(19) United States
(12) Patent Application Publication
(10) Pub. No.: US 2004/0091849 A1
(43) Pub. Date: May 13, 2004

(54) Writing boards

(76) Inventors: Christopher M. Gallant, Nottingham, NH (US); Joseph R. Levesque, Londonderry, NH (US); Howard A. Kingsford, Amherst, NH (US); Thomas J. Schnorberger, Monroe, MI (US)

Correspondence Address: JAMES W. BABINEAU, Fish & Richardson P.C., 225 Franklin Street, Boston, MA, 02110-2804, US

(21) Appl. No.: 10/293,383

(22) Filed: Nov. 12, 2002

(51) Int. Cl. B43L 1/00

(52) U.S. Cl. 434/408

(57) ABSTRACT

A flexible writing board has either adhesive or hook-and-loop fastening means on the back to adhere it to a wall surface.

### TECHNICAL FIELD

This document relates to writing boards. More particularly, this document relates to mountable writing boards, such as dry-erasable boards.

### BACKGROUND

Hanging writing boards are useful for efficiently conveying information in, for example, the office or the classroom. In particular, dry-erasable writing boards are especially well-suited for this purpose. By “dry-erasable,” it is meant that the boards are capable of being marked with a dry-erasable ink that can later be removed with, for example, a dry soft cloth, a tissue, or a whiteboard eraser. Dry-erasable boards in use today are typically hung from the wall with substantial hardware. This requirement for hardware tends to make it difficult to hang dry-erasable boards in spaces like cubicles and temporary offices, where the walls cannot handle the impact of the hardware. One solution to this problem has been to hang the dry-erasable board with hook-shaped brackets that extend over the top edge of the wall of the cubicle or temporary office.

Dry-erasable boards come in varying sizes because they serve many different needs. For example, large boards can be used for diagramming in a company meeting, while smaller boards can be used in the home for relaying messages. The large boards can be inconvenient to transport between locations because of their size and awkward shape. While the smaller boards are easier to carry, their rigidity prevents them from being compacted into an even smaller shape.

### SUMMARY

In general, the invention features writing boards and methods of making and using such boards. By “board,” we do not mean to imply any particular rigidity, thickness, stiffness, material, or size.

In one aspect, the invention features a writing board. The writing board includes a base with a writing surface and an opposite surface and a plurality of male fastener elements. Each male fastener element has a stem molded integrally with and extending from the opposite surface of the base.

In some embodiments, the writing surface of the writing board is dry-erasable.

In other embodiments, the male fastener elements include hooks. The hooks preferably have a height of less than about 0.05 inch (1.27 millimeters), e.g., between about 0.005 and 0.05 inch (0.127 and 1.27 millimeters). In some cases, the hooks are arranged in an array that covers substantially all of the opposite surface. The hook density on the opposite surface preferably is at least about 100 hooks per square inch, e.g., at least about 1000 hooks per square inch. The male fastener elements may include stems with rounded or planar heads (mushrooms). The mushrooms preferably have a height of less than about 0.05 inch (1.27 millimeters), e.g., between about 0.005 and 0.05 inch (0.127 and 1.27 millimeters). In some cases, the mushrooms are arranged in an array that covers substantially all of the opposite surface. The mushroom density on the opposite surface preferably is at least about 100 mushrooms per square inch, e.g., at least about 1000 mushrooms per square inch.

The writing board preferably weighs less than about 0.5 grams per square inch, e.g., less than about 0.1 grams per square inch.

In some embodiments, the male fastener elements are arranged in a bi-directional array or alternatively, in a uni-directional array. In some cases, the male fastener elements are configured to engage with a surface of a fabric-covered panel.

The writing board preferably has a Gurley stiffiess of less than about 35,000 milligrams, e.g., less than about 1,000 milligrams, as measured by TAPPI test method T 5430M-94 per ASTM E171-87. The writing board preferably has an overall thickness of less than about 0.125 inch (3.175 millimeters), e.g., between about 0.008 and 0.125 inch (0.203 and 3.175 millimeters). In some embodiments, the writing board has holes in it so that the writing board can be placed in a binder or notebook. The writing board preferably includes a low-energy thermoplastic, e.g., polypropylene, polyethylene, Nylon, or a polymer blend.

In some cases, the writing surface includes a low-energy thermoplastic, and the male fastener elements include a different thermoplastic, e.g., the writing surface includes polyethylene and the male fastener elements include a thermoplastic elastomer.

In some embodiments, the male fastener elements form an array that extends at least around a perimeter of the opposite surface. Alternatively, in other embodiments, the array extends over substantially the entire opposite surface of the board.

In some cases, the writing surface, the opposite surface and the fastener elements are integrally formed of a single, contiguous resin material. In some embodiments, the resin material may be formulated to be dry-erasable as the writing surface.

In some cases, each of the fastener elements has a molded loop-engageable portion at a distal end of its stem.

In some embodiments, the base includes a membrane molded integrally with the fastener element stems, and a coating applied to a broad surface of the membrane to form the writing surface. In other embodiments, the base includes a membrane of a first material of which the fastener element stems are integrally molded, and a second material permanently laminated to a broad surface of the membrane to form the writing surface.

In another aspect, the invention features a dry-erasable writing board including a base with a dry-erasable writing surface and an opposite surface, the base including a low-energy thermoplastic, and having an overall thickness of less than about 0.125 inch (3.175 millimeters), and a plurality of molded male fastener elements extending from the opposite surface. Various embodiments of this aspect of the invention contain features recited above for the first aspect of the invention.

The base preferably includes a low-energy thermoplastic having a dyne level of less than about 40 dynes per centimeter, e.g., between about 18 and 37 dynes per centimeter.

Another aspect of the invention features a writing board with a base in the form of a unitarily formed sheet of polymer having both a dry-erasable writing surface and an opposite surface, and a layer of adhesive in direct contact with the opposite surface, the adhesive being configured to engage a wall surface, and the writing board having sufficient flexibility to be manually rolled into a cylinder. Various embodiments of this aspect of the invention contain features recited above for the first aspect of the invention.

In some embodiments, two dry-erasable writing boards according to this aspect of the invention are stacked. One dry-erasable board is releasably engaged to the other dry-erasable writing board by a layer of adhesive.

In some embodiments, the writing board includes a plurality of male fastener elements extending from the opposite surface.

Another aspect of the invention features a method of making a dry-erasable writing board. The method includes extruding a thermoplastic material to form a sheet-form base having a sufficient thickness to allow the base to function as a writing board, and electing the width of the sheet-form base to be at least as great as a desired width of the writing board. The method further includes configuring a first broad surface of the base to function as a dry-erasable writing surface, and forming a plurality of male fastener elements extending integrally from an opposite broad surface of the sheet-form base.

In some cases, the method of making a dry-erasable writing board includes configuring the male fastener elements for cooperative engagement with a surface of a fabric-covered panel.

In some cases, the forming of male fastener elements includes forming hooks. In other cases, the forming of male fastener elements includes integrally molding preform stems extending from the base, and then deforming the molded stems to form the male fastener elements.

In some cases, the width of the sheet-form base is greater than the width of the board, and the method includes forming splitting channels in the sheet-form base to create a plurality of writing boards having the desired width.

In some cases, the method of making a dry-erasable writing board includes extruding a second thermoplastic material onto the base and forming the male fastener elements from the second thermoplastic material. The thermoplastic material preferably is a low-energy material.

The base thickness and material preferably are selected to give the writing board a Gurley stiffness of less than about 35,000 milligrams, e.g., less than about 1,000 milligrams.

In some cases, the method includes selecting the resin of the base to form a dry-erasable surface, so that the first broad surface of the base is configured to function as a dry-erasable writing surface. In other cases, the method includes applying a dry-erasable material to the first broad surface of the base so that the first broad surface of the base is configured to function as a dry-erasable writing surface.

Another aspect of the invention features a method of forming erasable marks on a writing surface. The method includes securing a writing board with a base having a writing surface and an opposite surface, and a plurality of male fastener elements, each fastener element having a stem molded integrally with and extending from the opposite surface, to a surface. Thereafter, the method includes forming a mark on the writing surface of the writing board with a dry-erasable marker, and later erasing the mark from the writing surface.

In some cases, erasing includes wiping the writing surface with a dry cloth or whiteboard eraser.

Implementations of the invention may have one or more of the following advantages. The writing boards can occupy a reduced amount of wall space by requiring little to no extra hardware. Because the writing boards can be mounted on a cubicle wall without brackets that extend over the top edge of the wall, encroachment into an adjacent cubicle is avoided and the boards may be mounted at any desirable level. Additionally, because of reduced hardware requirements, use of the writing boards can result in enhanced protection of the surfaces to which they are attached. Furthermore, in some implementations the writing boards are relatively light, and therefore will inflict minimal downward stress upon the wall surfaces on which they are mounted. The low weight of such boards also results in low shipping costs, and makes it easy for a user of the writing board to transport the board from one area to another.

In some implementations the writing boards are sufficiently flexible to be rolled, thereby facilitating shipping and transport from one area to another, or storage or transport after or between uses. Furthermore, writing boards with adequate flexibility have the advantage of being able to conform to non-planar surfaces. For example, such flexible boards can be shaped around posts in convention halls. In terms of flexibility, it is preferable that the writing boards have a Gurley stiffness of less than about 35,000 milligrams, and more preferably less than about 1,000 milligrams.

The writing boards can have different lengths and widths to accommodate specific uses. For example, the writing board may be large, for those users desiring enough space to clearly convey diagrams and significant amounts of information. On the other hand, the writing board may be small, e.g., eight by eleven inches (203.2 by 279.4 millimeters) in size or less, to accommodate those users who wish to easily transport the article between different locations (for example, from a notebook to a cubicle wall). The writing boards are also generally relatively inexpensive.

Writing boards of certain aspects of the invention can have a hook-bearing backing to attach to fabric-covered walls or an adhesive backing to attach to smooth walls. In other aspects of the invention, writing boards can have both a hook-bearing backing and an adhesive backing.

Other features and advantages of the invention will be apparent from the description and drawings, and from the claims.

### DESCRIPTION OF DRAWINGS

FIG. 1 is a diagrammatic perspective view of a cubicle, including a writing board according to one embodiment of the invention.

FIG. 2 is a diagrammatic side view, in partial cross-section, of the writing board and cubicle wall shown in FIG. 1.

FIG. 3 is an enlarged diagrammatic side view, in partial cross-section, of the writing board and cubicle wall shown in FIG. 2.

FIG. 4 is a perspective view of a portion of a writing board according to one embodiment of the invention.

FIG. 4A is an enlarged perspective view of a flat-topped mushroom hook, used in an alternative embodiment of the invention.

FIG. 4B is an enlarged perspective view of a palm tree hook, used in an alternative embodiment of the invention.

FIG. 5 is a diagrammatic perspective view of a rolled-up writing board.

FIG. 6 is a perspective view of a portion of a writing board according to an alternative embodiment of the invention.

FIG. 7 is a diagrammatic side view showing a process for making the writing board of FIG. 4.

FIG. 7A is a diagrammatic side view showing an alternative process for making the writing board of FIG. 6.

FIG. 7B is a diagrammatic side view showing an alternative process for making the writing board of FIG. 6.

FIG. 8 is a diagrammatic perspective view of a sheet including multiple writing boards that are separable along splitting channels.

FIG. 8A is a perspective view of a portion of a writing board according to an alternative embodiment of the invention.

FIG. 9 is a diagrammatic perspective view of the hook-carrying side of a writing board, in which the hooks are arranged around the perimeter of the surface, according to one embodiment of the invention.

FIG. 9A is a perspective view of a portion of a writing board according to an alternative embodiment of the invention.

FIG. 9B is a perspective view of a portion of writing board according to an alternative embodiment of the invention.

FIG. 9C is a diagrammatic side view showing a process for making the writing board of FIG. 9A.

FIG. 9D is a diagrammatic side view showing a process for making the writing board of FIG. 9B.

FIG. 10 is a diagrammatic side view, in partial cross-section, of a writing board with an adhesive backing, attached to a smooth wall, according to one embodiment of the invention.

FIG. 11 is a diagrammatic perspective view of the hook-carrying side of a writing board, in which the hooks are arranged along one length of the surface, and an adhesive strip is arranged along another length of the surface, according to one embodiment of the invention.

FIG. 11A is a diagrammatic perspective view of a stack of writing boards, according to one embodiment of the invention

Like reference symbols in the various drawings indicate like elements.

### DETAILED DESCRIPTION

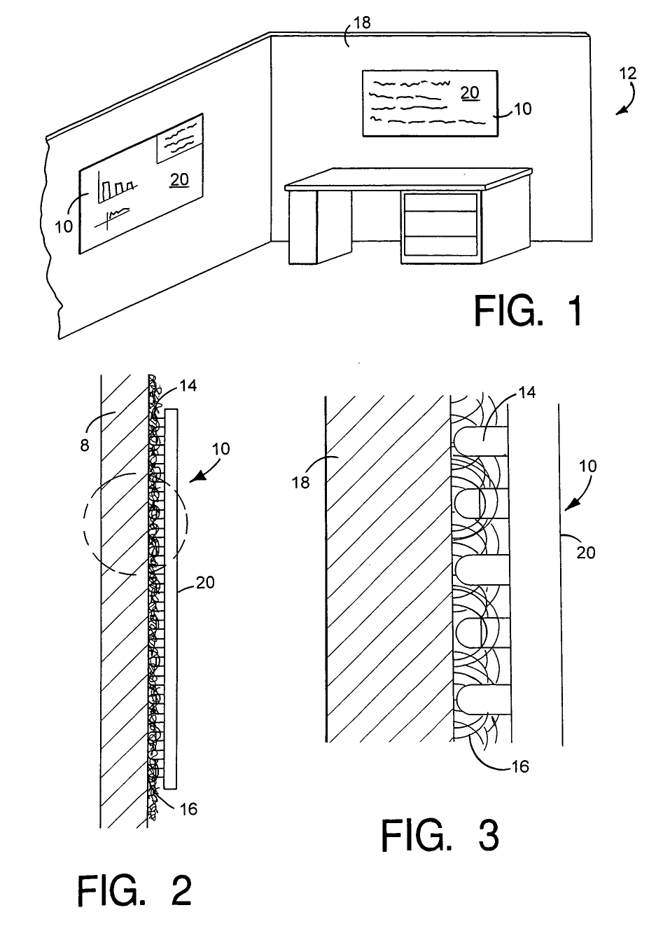

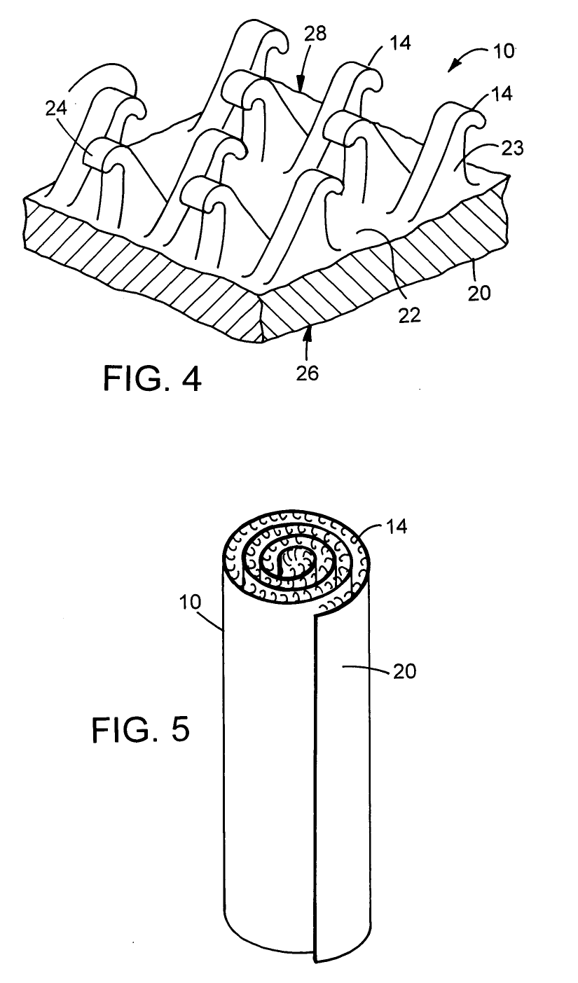

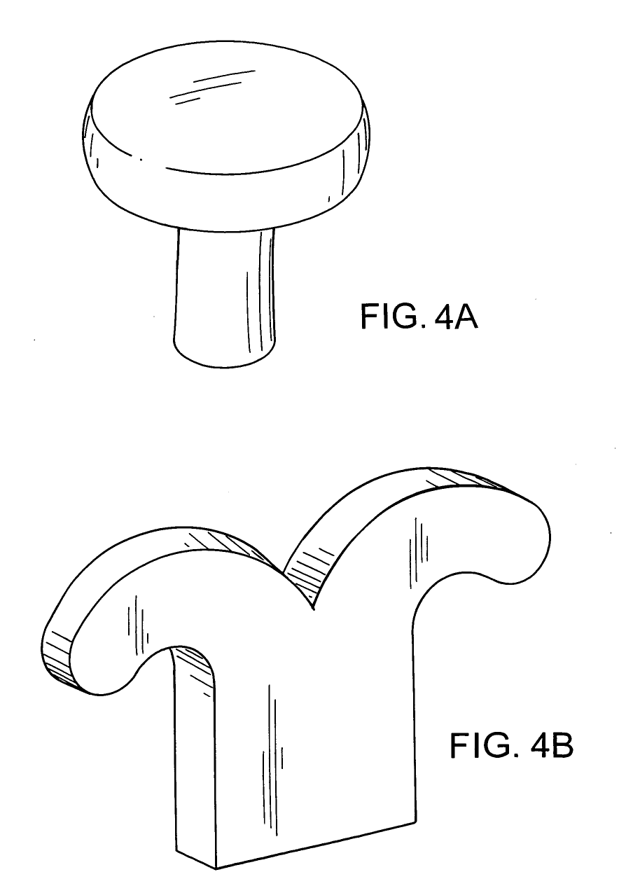

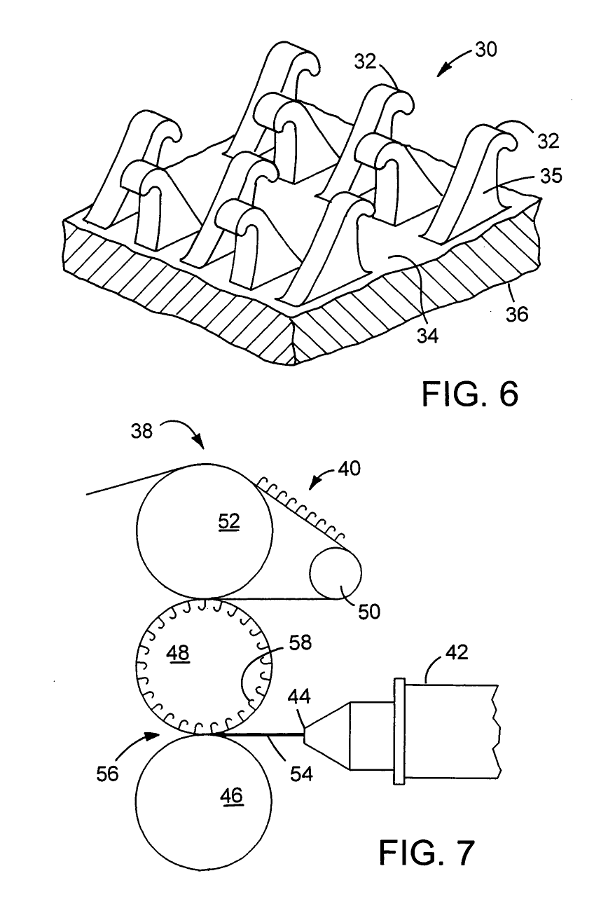

FIG. 1 shows two writing boards 10, mounted in a cubicle 12. As shown in FIGS. 2 and 3, each writing board 10 includes hooks 14 (shown in detail in FIGS. 4 and 6, and described further below) which engage the fabric surface 16 of wall 18 of cubicle 12. The writing board 10 can be detached from wall 18 by pulling the board from the wall, such that the board's hooks 14 are disengaged from the fabric surface 16 of wall 18. Writing surface 20 faces away from wall 18, toward the interior of cubicle 12.

Referring to FIG. 4, a portion of writing board 10 is shown. Writing board 10 includes a plurality of molded hooks 14 that are integral with, and extend from, a sheet-form base 22. The hooks 14 each have a stem 23. The hooks 14 are generally very fine, to enable them to engage the fabric surface 16 of cubicle wall 18. Suitable hooks preferably have a height of less than about 0.05 inch (1.27 millimeters), and preferably between about 0.005 inch (0.127 millimeter) and 0.05 inch (1.27 millimeters). A suitable hook is disclosed in U.S. Pat. No. 5,900,350, the entire contents of which are incorporated by reference herein.

By “hook,” we mean male touch fastener elements. While the hooks shown in FIG. 4 are inverted J-shape hooks, other types of hooks can be used. The hooks can be in many different shapes, including inverted J-shape, flat-topped mushroom (FIG. 4A), and palm tree (FIG. 4B). The hooks 14 are arranged in an array, extending over the surface of sheet-form base 22. The array may have a relatively high hook density, e.g., a hook density of at least about 1000 hooks per square inch, preferably from about 1000 to 8000 hooks per square inch, and more preferably from about 1600 to 2000 hooks per square inch. This high hook density prevents the user of the board from perceiving discontinuities in the writing surface of the board. Alternatively, the hook density may be relatively low if the hooks are small enough so that they can penetrate the cubicle wall fabric and so that the hooks will not be perceived as discontinuities in the writing surface when the board is in use.

The hooks 14 are arranged bi-directionally, i.e., the crooks 24 of the hooks face in two opposite directions. As a result, the user of the writing board 10 does not have to orient the board “right side up” when hanging it; as long as the user orients the board with one of its long edges up, as shown in FIG. 1, hooks will engage the cubicle fabric.

Preferably, the base is sufficiently thin and flexible so that the writing board 10 can be rolled up, as shown in FIG. 5, or even folded. Generally, the base 22 has a thickness of from about 0.003 to 0.015 inch (0.0762 to 0.381 millimeter). A flexible base allows the user to more easily transport writing board 10 between various locations, such as the home and the office. Furthermore, a rolled-up writing board may be easier to store than an inflexible writing board, as a result of the rolled-up board's less awkward shape. Additionally, a more flexible writing board can more easily conform to non-planar surfaces.

The overall thickness of writing board 10 preferably is less than about 0.125 inch (3.175 millimeters) thick, and more preferably is between about 0.008 and 0.125 inch (0.203 and 3.175 millimeters) thick. By “overall thickness of the writing board”, we mean to refer to the sum total of the height of the hooks and the base thickness. The relatively low overall thickness of the writing board 10 renders the board advantageously light. For example, a board having a size of about eight by eleven inches (203.2 by 279.4 millimeters) would generally weigh less than ten grams, while a board having a size of 36 by 48 inches (914.4 by 1219.2 millimeters) would generally weigh less than 200 grams. By contrast, a conventional dry erase writing board of this size may weigh about ten pounds (4535.9 grams). The writing board 10 preferably weighs less than about 0.5 gram per square inch, and typically weighs less than about 0.1 gram per square inch.

Referring again to FIG. 4, writing surface 20 is provided on the side 26 that is opposite to the hook-carrying side 28 of the sheet-form base 22. The sheet-form base 22, the hooks 14, and the writing surface 20 are formed from a thermoplastic polymer. The writing surface 20 is an erasable writing surface, preferably a dry-erasable surface, i.e., a surface that can receive markings made with a dry-erase marker and from which such markings can be erased using a dry soft cloth, tissue, or whiteboard eraser. In order to provide dry-erasability, it is generally preferred that the thermoplastic be a low surface energy material, for example a polyolefin (e.g., polypropylene, polyethylene) or Nylon. By low surface energy material, it is meant that the material has a dyne level below about 40 dynes per centimeter, as measured by TAPPI test method T698 per ASTM D 2578. However, in order to avoid the problem of the ink forming beads and running down the writing board 10, the material preferably has a dyne level of about 18 to 37 dynes per centimeter.

Dry erase properties may be enhanced, if desired, by adding an additive to modify the surface energy of the finished product, such as a slip agent or release agent, for example, a fluoropolymer, e.g., Lumiflon LF-200, commercially available from Bellex International Corp., to the base resin. Suitable additives will generally reduce the porosity and/or the surface energy of the polymer, or otherwise alter the surface characteristics of the writing surface so as to enhance erasability.

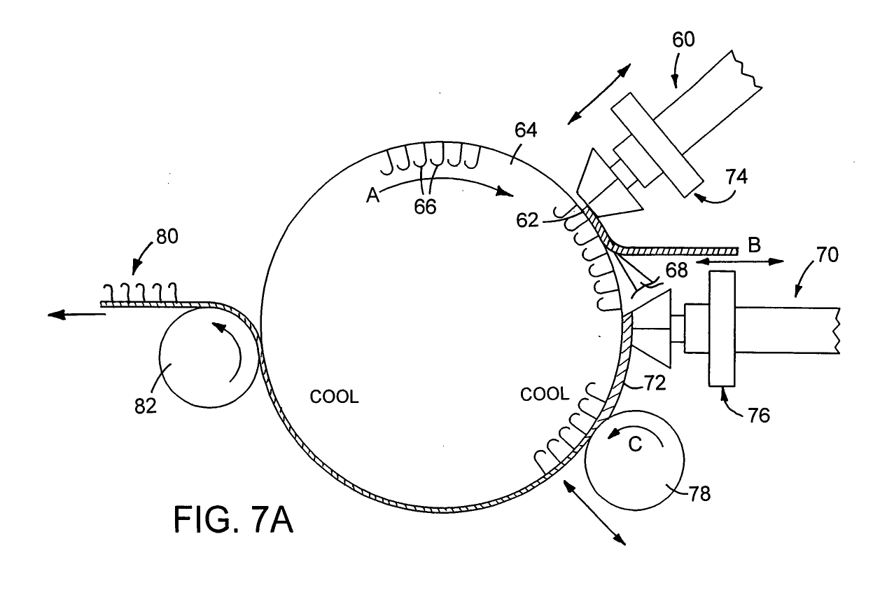

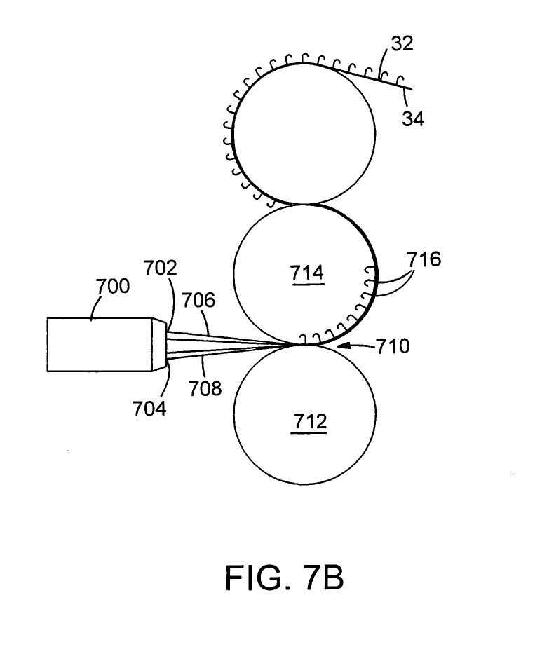

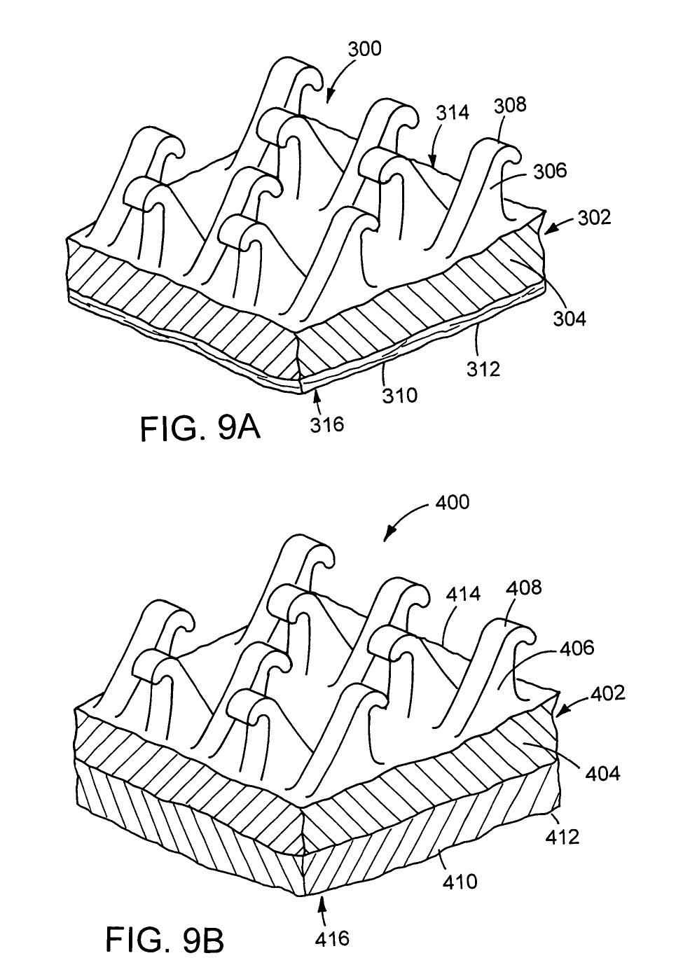

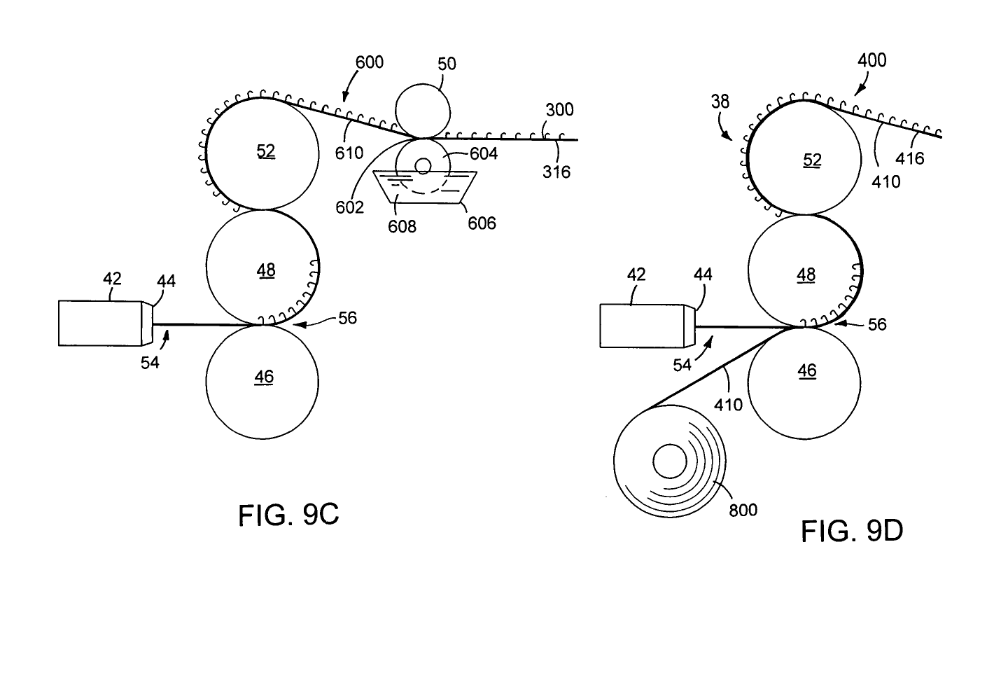

Referring now to FIG. 6, a portion of another writing board 30 is shown. Writing board 30 includes a plurality of molded hooks 32 that are extruded onto a sheet-form base 34, e.g., as described below with reference to FIG. 7A. The hooks 32 each have a stem 35. The writing board 30 generally has the same properties as described above with reference to writing board 10. If desired, in this case two different polymers can be used to form hooks 32 and base 34. For example, the use of two different polymers can allow the base 34 to exhibit certain properties, e.g., flexibility or enhanced dry-erasability of writing surface 36, that would not be exhibited by a polymer that would provide optimal hook properties, e.g., flexibility, for a particular application. For instance, the base 34 could be formed of polypropylene, while the hooks 32 could be formed of a material having greater flexibility and softness, e.g., a thermoplastic elastomer for example, a Santoprene™ elastomer (commercially available from Advanced Elastomer Systems). Such a writing board can be formed by coextruding the base and the hooks (e.g., as shown in FIG. 7B and described below), or by laminating the base onto the hooks (e.g., as shown in FIG. 9D and described below) through the use of common laminating techniques, i.e., flame or adhesive lamination.

FIG. 7 illustrates a suitable process for forming the writing board 10 shown in FIG. 4. Writing board 10 is formed by an extrusion apparatus 38 including a molding/calendaring assembly 40. Assembly 40 includes an extruder barrel 42, a slot-form die 44, a base roll 46, a mold roll 48, a take-off roll 50, and a guide roll 52.

In use, extruder barrel 42 melts a plastic resin and forces the molten plastic through slot-form die 44, to form a sheet-form extrudate of molten plastic 54. The extruded plastic 54, while still molten, enters a nip 56 formed between a base roll 46 and a mold roll 48. As described in detail in U.S. Pat. No. 4,794,028, the disclosure of which is incorporated herein by reference, due to pressure applied at the nip by rolls 46, 48, molten resin is forced into hook cavities 58, forming the hooks 14 described above.

FIG. 7A shows an alternate process for forming the writing board 30, shown in FIG. 6, in which the hooks are post-formed onto the base 34. As shown in FIG. 7A, a first extruder 60 extrudes a first, hook-forming polymer 62 onto mold roll 64, forcing some of the polymer into hook-forming cavities 66 and leaving a layer of polymer on the surface of the mold roll. As mold roll 64 rotates in the direction of arrow A, doctoring blade 68 removes some or all of the polymer on the surface of the mold roll without disturbing the polymer in cavities 66. The removed polymer, which has been exposed to air while on the mold roll and may have begun to solidify, may be either discarded or returned to the hopper for re-melting. The thickness of the polymer left on the surface of the roll by the doctoring blade will depend, in part, on how closely the blade is positioned to the surface of the mold roll (the position is adjustable in the direction indicated by arrow B). In some cases, the sharp, distal end of blade 68 rides against the mold roll, thereby scraping off essentially all of the polymer on the surface of the roll. In such cases it is recommended that the end of the blade be coated with a lubricious material to avoid damaging the surface of the mold roll. In other cases, the position of the blade is adjusted to leave a predetermined thickness of polymer on the roll, to become a part of the base of the product. In such cases, the doctoring blade effectively trims the polymer thickness rather than actually “scraping” against the surface of the roll. Next, a second extruder 70 extrudes a second, base-forming polymer 72 onto the surface of the mold roll (or onto any polymer 62 left on the surface of the roll by blade 68). A gear pump 74, 76, is positioned at the outlet of each extruder, to accurately control the rate of polymer delivered to the mold roll. The final thickness of the base of the product is then adjusted by roll 78, rotating in the direction of arrow C, and the finished fastener product 80 is stripped from the mold roll 64 by passing it around exit roll 82.

Referring now to FIG. 7B, a coextrusion process for forming writing board 30 is shown. In FIG. 7B, an extruder barrel 700 melts two types of plastic resin and forces the molten resin through two slot-form dies, 702 and 704, thereby forming two sheet-form extrudates, 706 and 708. The two sheet-form extrudates enter a nip 710. Due to pressure applied at the nip by rolls 712, 714, sheet-form extrudate 706 is forced into hook cavities 716, forming the hooks 32 described above, and sheet-form extrudate 708 is molded to the backs of the hooks 32 to form the base 34.

A possible additional processing step for the above sheet-form bases entails forming splitting channels in the sheet-form base in the machine direction. These splitting channels would be formed concurrently with the creation of the sheet-form base by the extrusion apparatus 38 (FIG. 7). Thereafter, and at a separate processing station, the sheet-form base could be cut in the cross-machine direction. The end result would be a sheet made up of, for example, three individual boards, separated by splitting channels. This further processing step could accelerate the manufacturing process by resulting in the production of a larger quantity of boards in a shorter period of time. Rather than cutting the molded product transversely at a downstream station, the product could be perforated or scored, resulting in a longitudinally continuous product that could later be torn or severed into boards of a desirable length.

Other embodiments are within the scope of the claims. For example, the writing boards can be small or large in size, depending on the task at hand. In one embodiment, the writing board can be about eight by eleven inches (203.2 by 279.4 millimeters) in size, and can include holes in a three-hole punch pattern, so that the writing board may be stored and transported by the user in a notebook or binder.

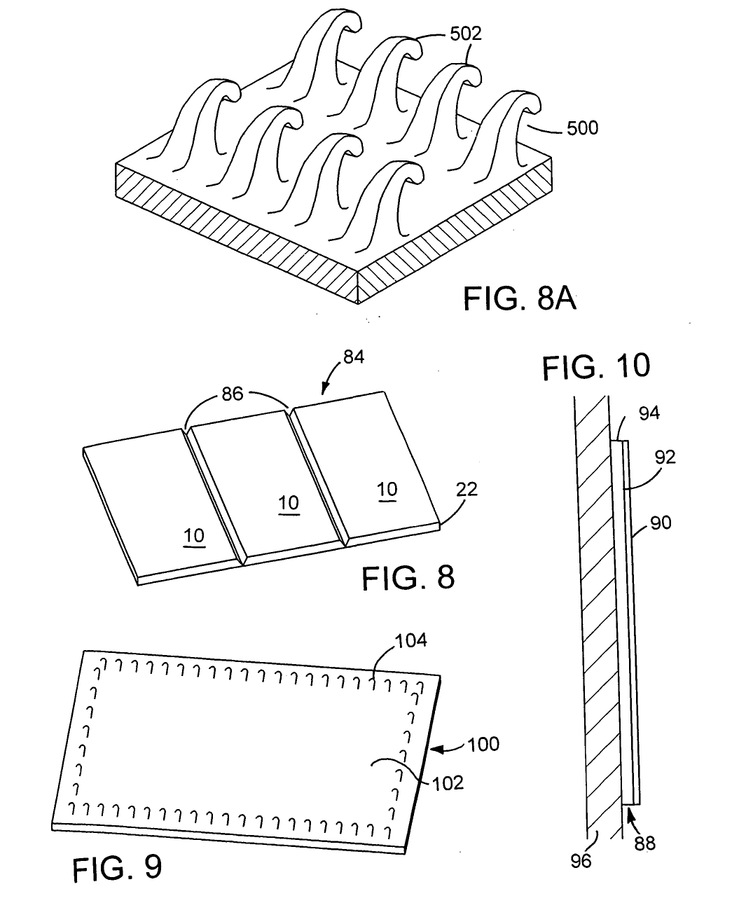

Also, in another embodiment writing board 10 can be produced in a repeated pattern across a wide sheet, with splitting channels separating individual writing boards. An example of such a sheet is depicted in FIG. 8, in which one sheet 84 contains three separable writing boards 10. When the manufacturer or user wishes to separate the boards, the boards may be pulled apart or otherwise severed along the splitting channels 86. Additionally, if writing board 10 is produced in long sheets separated by splitting channels, then a flexible base 22 allows the sheets themselves to be rolled up. In this way, the end user can buy multiple writing boards 10 in one convenient tube, and can later separate those writing boards along the splitting channels.

Moreover, the hooks need not be arranged bidirectionally, as discussed above and shown in FIGS. 4 and 6. Instead, as shown in FIG. 8A, the hooks 500 can be arranged uni-directionally, i.e., so that their crooks 502 all extend in a single direction, and the user can be instructed to orient the board accordingly during mounting.

Referring now to FIG. 9, in another embodiment the hook-bearing surface 102 of writing board 100 can have hooks 104 along its perimeter. Such an arrangement would allow the user to more easily detach the writing board from the surface of the wall.

Referring to FIG. 9A, a portion of writing board 300 according to one embodiment of the invention is shown. Writing board 300 includes a base 302 having a membrane 304 molded integrally with the stems 306 of the fastener elements 308. A coating 310 is applied to a broad surface on the side 312 opposite the hook-bearing side 314 of writing board 300. The coating 310 forms the writing surface 316 of writing board 300.

Referring now to FIG. 9B, a portion of a writing board 400 according to another embodiment of the invention is shown. Writing board 400 includes a base 402 having a membrane 404 molded integrally with the stems 406 of the fastener elements 408. A sheet material 410 is permanently laminated to a broad surface of membrane 404 on the side 412 opposite the hook-bearing side 414 of writing board 400. The sheet material 410 forms the writing surface 416 of writing board 400.

Referring now to FIG. 9C, a process for forming a writing board according to FIG. 9A is shown. The extruder barrel 42, slot-form die 44, base roll 46, mold roll 48, take-off roll 50, guide roll 52, extruded plastic 54, and nip 56 are substantially the same as those shown in FIG. 7 and described above. To form a writing board 300 as shown in FIG. 9A and described above, a hook-carrying web 600 is formed in the same manner described above with reference to FIG. 7. After web 600 rolls off of guide roll 52, it enters a nip 602 between take-off roll 50 and a coating roll 604. A portion of coating roll 604 is disposed in a bath 606 of a coating material 608. The coating material 608 is transferred to the non-hook-carrying surface 610 of the hook-carrying web 600 to form the writing surface 316 of the finished writing board 300. The coating material 608 is selected to impart dry-erasability and other desired characteristics to the writing surface.

Referring to FIG. 9D, to form writing board 400 as shown in FIG. 9B, sheet material 410 is fed from a roll 800 into the nip 56. As extruded plastic 54 enters nip 56, the sheet material 410 is laminated to a surface of the extruded plastic 54. Hooks are then formed on an opposite surface of the extruded plastic 54, as described above with reference to FIG. 7. As a result, the final product is writing board 400, which includes writing surface 416 formed of sheet material 410.

Furthermore, instead of using an array of hooks to engage the wall, the writing board may include a rubber-based removable adhesive, e.g., National Starch Multi-lok 38454A, that would be capable of engaging a painted wall surface and subsequently being removed therefrom without damaging the paint. FIG. 10 shows a writing board 88 having a writing surface 90 and a back surface 92 that carries a layer of peelable adhesive 94. As shown in FIG. 10, the layer of adhesive 94 is capable of engaging a smooth, hard surface 96, such as a painted wall. For boards of a size to be generally rolled up for storage or transport, the adhesive is preferably formulated to not adhere strongly to the writing surface, or a removable release liner may be employed.

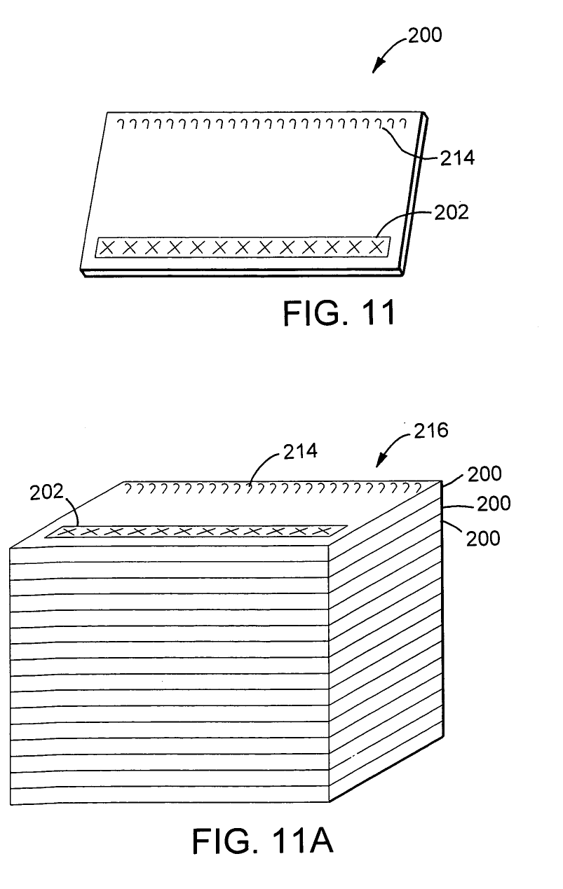

A layer of adhesive may also be used in addition to an array of hooks. In this case, the writing board can engage both fiber-bearing cubicle walls and smooth surfaces such as painted walls. For example, as shown in FIG. 11, a writing board 200 includes a strip of adhesive 202 extending along one edge of the board, and an array of hooks 214 extending along an opposite edge of the board. In this case, the writing boards 200 can be sold in a stack 216 (FIG. 11A), with each writing board adhered to the adjacent board in the stack by its adhesive strip 202. The user can then separate the writing boards, and adhere each writing board to the wall by its hooks 214 or to a smooth surface by its adhesive strip 202. In other embodiments, the hook-bearing surface of the writing board can include more than one strip of hooks and/or more than one strip of adhesive, and/or the strip(s) of adhesive and strip(s) of hooks can be positioned on the same edge of the board. Moreover, the hook-bearing surface of the writing board can include an adhesive covering its entire surface, as well as one or more strips of hooks or an array of hooks covering its entire surface.

What is claimed is:

1. A writing board comprising:
a base defining a writing surface and an opposite surface; and
a plurality of male fastener elements, each fastener element having a stem molded integrally with and extending from the opposite surface.

2. The writing board of claim 1, wherein the writing surface is dry-erasable.

3. The writing board of claim 1, wherein the male fastener elements comprise hooks.

4. The writing board of claim 3, wherein the hooks have a height of less than about 0.05 inch (1.27 millimeters).

5. The writing board of claim 4, wherein the hooks have a height of between about 0.005 and 0.05 inch (0.127 and 1.27 millimeters).

6. The writing board of claim 3, wherein the hooks are arranged in an array uniformly covering substantially all of the opposite surface.

7. The writing board of claim 6, wherein the hook density on the opposite surface is at least about 100 hooks per square inch.

8. The writing board of claim 7, wherein the hook density on the opposite surface is at least about 1000 hooks per square inch.

9. The writing board of claim 1, wherein the writing board weighs less than about 0.5 grams per square inch.

10. The writing board of claim 9, wherein the writing board weighs less than about 0.1 grams per square inch.

11. The writing board of claim 1, wherein the male fastener elements are arranged in a bi-directional array.

12. The writing board of claim 1, wherein the male fastener elements are arranged in a uni-directional array.

13. The writing board of claim 1, wherein the male fastener elements are configured for cooperative engagement with a surface of a fabric-covered panel.

14. The writing board of claim 1, wherein the writing board has a Gurley stiffniess of less than about 35,000 milligrams.

15. The writing board of claim 14, wherein the writing board has a Gurley stiffness of less than about 1,000 milligrams.

16. The writing board of claim 1, wherein the writing board has an overall thickness of less than about 0.125 inch (3.175 millimeters).

17. The writing board of claim 16, wherein the overall thickness of the writing board is between about 0.008 and 0.125 inch (0.203 and 3.175 millimeters).

18. The writing board of claim 1, wherein the writing board defines holes configured to receive a fastening portion of a binder or notebook.

19. The writing board of claim 1, wherein the writing board comprises a low-energy thermoplastic.

20. The writing board of claim 19, wherein the writing board comprises polypropylene.

21. The writing board of claim 19, wherein the writing board comprises polyethylene.

22. The writing board of claim 19, wherein the writing board comprises Nylon.

23. The writing board of claim 19, wherein the writing board comprises a polymer blend.

24. The writing board of claim 1, wherein the writing surface comprises a low-energy thermoplastic, and the male fastener elements comprise a different thermoplastic.

25. The writing board of claim 24, wherein the writing surface comprises polyethylene and the male fastener elements comprise a thermoplastic elastomer.

26. The writing board of claim 1, wherein the male fastener elements are disposed in an array that extends at least around a perimeter of the opposite surface.

27. The writing board of claim 1, wherein the array extends over substantially the entire opposite surface of the board.

28. The writing board of claim 1, wherein the writing surface, the opposite surface and the fastener elements are integrally formed of a single, contiguous resin material.

29. The writing board of claim 28, wherein the resin material is formulated to be dry-erasable as the writing surface.

30. The writing board of claim 1, wherein each of the fastener elements has a molded loop-engageable portion at a distal end of its stem.

31. The writing board of claim 1, wherein the base comprises a membrane molded integrally with the fastener element stems, and a coating applied to a broad surface of the membrane to form the writing surface.

32. The writing board of claim 1, wherein the base comprises a membrane of a first material of which the fastener element stems are integrally molded, and a second material permanently laminated to a broad surface of the membrane to form the writing surface.

33. A dry-erasable writing board comprising:
a base defining a dry-erasable writing surface and an opposite surface, the base comprising a low-energy thermoplastic, and having an overall thickness of less than about 0.125 inch (3.175 millimeters); and
a plurality of molded male fastener elements extending from the opposite surface.

34. The dry-erasable writing board of claim 33, wherein the writing board weighs less than about 0.5 gram per square inch.

35. The dry-erasable writing board of claim 34, wherein the writing board weighs less than about 0.1 gram per square inch.

36. The dry-erasable writing board of claim 33, wherein the writing board has a Gurley stiffness of less than about 35,000 milligrams.

37. The dry-erasable writing board of claim 36, wherein the writing board has a Gurley stiffness of less than about 1,000 milligrams.

38. The dry-erasable writing board of claim 33, wherein the male fastener elements comprise a different thermoplastic than the base.

39. The dry-erasable writing board of claim 38, wherein the base comprises polyethylene and the male fastener elements comprise a thermoplastic elastomer.

40. The dry-erasable writing board of claim 33, wherein the base comprises a low-energy thermoplastic having a dyne level of less than about 40 dynes per centimeter.

41. The dry-erasable writing board of claim 40, wherein the base comprises a low-energy thermoplastic having a dyne level of between about 18 and 37 dynes per centimeter.

42. A dry-erasable writing board comprising:
a base in the form of a unitarily formed sheet of polymer having both a dry-erasable writing surface and an opposite surface; and
a layer of adhesive in direct contact with the opposite surface, the adhesive being configured to engage a wall surface;
wherein the writing board has sufficient flexibility to be manually rolled into a cylinder.

43. In combination, two dry-erasable writing boards according to claim 42, wherein the dry-erasable writing boards are stacked with one dry-erasable writing board releasably engaged to the other dry-erasable writing board by a layer of adhesive.

44. The dry-erasable writing board of claim 42, wherein the writing board has a Gurley stiffness of less than about 35,000 milligrams.

45. The dry-erasable writing board of claim 44, wherein the writing board has a Gurley stiffness of less than about 1,000 milligrams.

46. The dry-erasable writing board of claim 42, wherein the writing board has an overall thickness of less than about 0.125 inch (3.175 millimeters).

47. The dry-erasable writing board of claim 46, wherein the writing board has an overall thickness of between about 0.008 inch (0.203 millimeter) and 0.125 inch (3.175 millimeters).

48. The dry-erasable writing board of claim 42, wherein the writing board weighs less than about 0.5 gram per square inch.

49. The dry-erasable writing board of claim 48, wherein the writing board weighs less than about 0.1 gram per square inch.

50. The dry-erasable writing board of claim 42, wherein the writing board defines holes configured to receive a fastening portion of a binder or notebook.

51. The dry-erasable writing board of claim 42, wherein the writing board comprises a low-energy thermoplastic.

52. The dry-erasable writing board of claim 51, wherein the writing board comprises polypropylene.

53. The dry-erasable writing board of claim 51, wherein the writing board comprises polyethylene.

54. The dry-erasable writing board of claim 51, wherein the writing board comprises Nylon.

55. The dry-erasable writing board of claim 51, wherein the writing board comprises a polymer blend.

56. The dry-erasable writing board of claim 42, wherein the board further comprises a plurality of male fastener elements extending from the opposite surface.

57. A method of making a dry-erasable writing board, the method comprising:
extruding a thermoplastic material to form a sheet-form base having a sufficient thickness to allow the base to function as a writing board, with the base having a width selected to be at least as great as a desired width of the writing board;
configuring a first broad surface of the base to function as a dry-erasable writing surface; and
forming a plurality of male fastener elements extending integrally from an opposite broad surface of the sheet-form base.

58. The method of claim 57 further comprising configuring the male fastener elements for cooperative engagement with a surface of a fabric-covered panel.

59. The method of claim 57, wherein said forming step comprises molding hooks.

60. The method of claim 57, wherein the forming step comprises integrally molding preform stems extending from the base, and then deforming the molded stems to form the male fastener elements.

61. The method of claim 57, wherein the width of the sheet-form base is greater than the width of the board, and the method further comprises forming splitting channels in the sheet-form base to define a plurality of writing boards having the desired width.

62. The method of claim 57, further comprising extruding a second thermoplastic material onto the base, wherein said molding step includes forming the male fastener elements from the second thermoplastic material.

63. The method of claim 57, further comprising selecting a low energy material as the thermoplastic material.

64. The method of claim 57, wherein the base thickness and material are selected to give the writing board a Gurley stiffness of less than about 35,000 milligrams.

65. The method of claim 64, wherein the base thickness and material are selected to give the writing board a Gurley stiffness of less than about 1,000 milligrams.

66. The method of claim 57, wherein configuring the first broad surface of the base to function as a dry-erasable writing surface comprises selecting the resin of the base to form a dry-erasable surface.

67. The method of claim 57, wherein configuring the first broad surface of the base to function as a dry-erasable writing surface comprises applying a dry-erasable material to the first broad surface of the base.

68. The method of claim 67, wherein configuring the first broad surface of the base to function as a dry-erasable writing surface comprises laminating a dry-erasable material to the first broad surface of the base.

69. The method of claim 67, wherein configuring the first broad surface of the base to function as a dry-erasable writing surface comprises coating a dry-erasable material onto the first broad surface of the base.

70. A method of forming erasable marks on a writing surface, the method comprising:
(a) securing a writing board having a base defining a writing surface and an opposite surface, and a plurality of male fastener elements, each fastener element having a stem molded integrally with and extending from the opposite surface, to a surface;
(b) forming a mark on the writing surface of the writing board with a dry-erasable marker; and thereafter
(c) erasing the mark from the writing surface.

71. The method of claim 70, wherein the male fastener elements comprise mushrooms.

72. The method of claim 70, wherein erasing the mark comprises wiping the writing surface with a dry cloth or whiteboard eraser.

73. The writing board of claim 1, wherein the male fastener elements comprise mushrooms.

74. The dry-erasable writing board of claim 33, wherein the male fastener elements comprise mushrooms.

75. The method of claim 57, wherein the male fastener elements comprise mushrooms.
